(19) United States
(12) Patent Application Publication
(10) Pub. No.: US 2026/0274670 A1
(43) Pub. Date: Sep. 17, 2026

(54) METHOD FOR RECYCLING CERAMIC SINTERED BODY

(71) Applicant: Kabushiki Kaisha Toshiba, Kawasaki-shi (JP)

(72) Inventors: Jian Cao, Yokohama Kanagawa (JP); Masako Kobayashi, Kawasaki Kanagawa (JP); Maho Hayase, Yokohama Kanagawa (JP); Masaaki Hirakawa, Yokohama Kanagawa (JP)

(21) Appl. No.: 19/407,981

(22) Filed: Dec. 3, 2025

(30) Foreign Application Priority Data
Mar. 17, 2025 (JP) 2025-042741

(51) Int. Cl. C01B 21/068; C22B 1/24; C22B 3/22; C22B 7/00; C22B 26/22; C22B 34/12; C22B 59/00

(52) U.S. Cl. CPC C01B 21/0687; C22B 1/24; C22B 3/22; C22B 7/007; C22B 26/22; C22B 34/1245; C22B 34/1259; C22B 59/00

(57) ABSTRACT

According to one embodiment, a method for recycling a ceramic sintered body includes bringing a ceramic sintered body including at least one metal element selected from the group consisting of a rare earth element, Ti, and Mg into contact with an acidic liquid including at least one selected from the group consisting of hydrochloric acid, nitric acid, and sulfuric acid in a pressure atmosphere at a temperature of from 100° C. to 400° C. to obtain a mixture including a main component of the ceramic sintered body and an ion of the at least one metal element present in the acidic liquid, separating the main component of the ceramic sintered body from the mixture and separating the ion of the at least one metal element from the acidic liquid.

### CROSS-REFERENCE TO RELATED APPLICATION

This application is based upon and claiming the benefit of priority from Japanese Patent Application No. 2025-042741, filed Mar. 17, 2025, the entire contents of which are incorporated herein by reference.

### FIELD

Embodiments described herein relate generally to a method for recycling a ceramic sintered body.

### BACKGROUND

As ceramic materials, silicon nitride ceramic sintered bodies, aluminum nitride ceramic sintered bodies, silicon carbide ceramic sintered bodies, titanium carbide ceramic sintered bodies, and the like are known. Among the ceramic sintered bodies described above, the silicon nitride ceramic sintered bodies are particularly excellent in hardness and toughness. It is required to establish a technique for separating and recovering a main component such as a ceramic and a filler such as an oxide of a rare earth or an oxide of a metal from these ceramic sintered bodies.

### BRIEF DESCRIPTION OF DRAWINGS

FIG. 1 is a flowchart showing an example of a flow of a method for recycling a ceramic sintered body according to a first embodiment.

FIG. 2 is a flowchart showing an example of a flow of a method for recycling a ceramic sintered body according to a second embodiment.

### DETAILED DESCRIPTION

According to an embodiment, it is possible to provide a method for recycling a ceramic sintered body capable of separating and recovering a main component and a filler containing a target metal element from a ceramic sintered body.

According to one embodiment, a method for recycling a ceramic sintered body including:
bringing a ceramic sintered body including at least one metal element selected from the group consisting of a rare earth element, Ti, and Mg into contact with an acidic liquid including at least one selected from the group consisting of hydrochloric acid, nitric acid, and sulfuric acid in a pressure atmosphere at a temperature of from 100° C. to 400° C. to obtain a mixture including a main component of the ceramic sintered body and an ion of the at least one metal element present in the acidic liquid;
separating the main component of the ceramic sintered body from the mixture; and
separating the ion of the at least one metal element from the acidic liquid.

### First Embodiment

A method for recycling a ceramic sintered body according to a first embodiment includes:
bringing a ceramic sintered body containing at least one metal element (hereinafter referred to as metal element M) selected from the group consisting of a rare earth element, Ti, and Mg into contact with an acidic liquid containing at least one selected from the group consisting of hydrochloric acid, nitric acid, and sulfuric acid in a pressure atmosphere at a temperature of 100° C. or higher and 400° C. or lower to obtain a mixture containing a main component of the ceramic sintered body and an ion of the metal element M present in the acidic liquid;
separating and recovering the main component of the ceramic sintered body from the mixture; and
separating and recovering the ion of the metal element M from the acidic liquid.

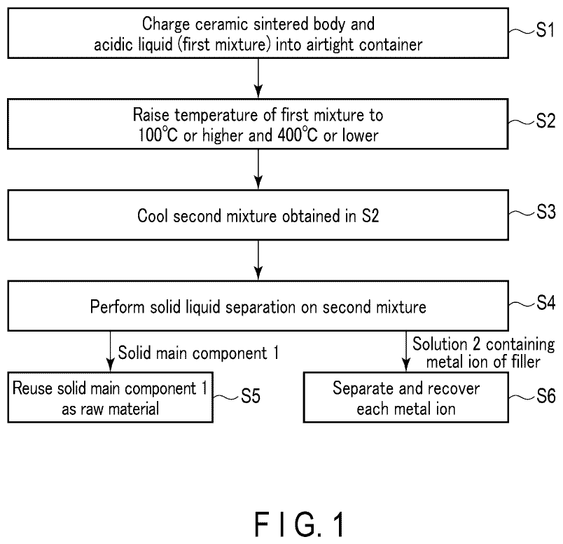

The method of the first embodiment will be described with reference to FIG. 1. First, a ceramic sintered body to be recycled will be described. The ceramic sintered body is not particularly limited as long as it can be recycled. The ceramic sintered body may be a waste material or a material scheduled to be discarded. The ceramic sintered body may be used or unused.

The ceramic sintered body contains a main component and a filler. The main component of the ceramic sintered body is formed of a ceramic constituent material such as silicon nitride (for example, Si₃N₄), aluminum nitride (for example, AlN), silicon carbide (for example, SiC), or titanium carbide (for example, TiC). The filler of the ceramic sintered body contains a metal element M. For the metal element M, the rare earth element is not particularly limited, and examples thereof can include Er, Y, Ce, Sc, La, Pr, Nd, Pm, Sm, Eu, Gd, Tb, Dy, Ho, Tm, Yb, and Lu. A form of the metal element M is not particularly limited, but, for example, an oxide of the metal element M can be used. Examples of the oxide of the metal element M include erbium oxide (for example, Er₂O₃), yttrium oxide (for example, Y₂O₃), titanium oxide (for example, TiO₂), magnesium oxide (for example, MgO), and Ce oxide (for example, CeO₂). The ceramic sintered body may contain a filler other than the oxide of the metal element M, for example, hafnium oxide (for example, HfO₂), Zr oxide, Al oxide, or Sr oxide. The type of the filler contained in the sintered body may be one or two or more. The filler is present, for example, at a crystal grain boundary of a ceramic such as silicon nitride. In the ceramic sintered body, a content of the main component is larger than a content of the filler. In a case where a weight of the main component is 1, a weight of the filler is desirably 0.002 or more.

A shape of the ceramic sintered body is not limited, but may be, for example, a plate shape, a rod shape, a spherical shape, a lump shape, or a granular shape. The shape of the ceramic sintered body may be the same, but may be a mixture of a plurality of shapes.

The method shown in FIG. 1 includes steps S1 to S6. Each step will be described below.

### <Step S1>

The ceramic sintered body and the acidic liquid are charged into an airtight container.

The acidic liquid contains at least one selected from the group consisting of hydrochloric acid (HCL), nitric acid (HNO₃), and sulfuric acid (H₂SO₄). The acidic liquid is desirably an acidic aqueous solution. Examples of the acidic liquid include a hydrochloric acid solution (aqueous hydrochloric acid solution), a nitric acid solution (aqueous nitric acid solution), a sulfuric acid solution (aqueous sulfuric acid solution), a mixed solution of hydrochloric acid and sulfuric acid (mixed aqueous solution), a mixed solution of nitric acid and sulfuric acid (mixed aqueous solution), and a mixed solution of hydrochloric acid and nitric acid (mixed aqueous solution).

An acid concentration of the acidic liquid is desirably 1% by weight or more and 30% by weight or less. By setting the acid concentration to 1% by weight or more, it is possible to promote dissolution of the filler containing the metal element M in the acidic liquid. In a case where the acid concentration is more than 30% by weight, sulfuric acid or nitric acid, which is an oxidizing agent, reacts with some metals to form a layer of oxide at surfaces thereof, which may interfere with further dissolution of the metals. In order to promote the dissolution of the filler while suppressing the cost, the acid concentration is desirably set to 18 by weight or more and 30% by weight or less.

The ceramic sintered body and the acidic liquid may be charged sequentially or simultaneously into the airtight container. In addition, the ceramic sintered body and the acidic liquid are mixed by, for example, a method of immersing the ceramic sintered body in the acidic liquid, or a method of adding the acidic liquid to the ceramic sintered body. The mixing may be performed in advance before charging into the airtight container, or may be performed in the airtight container after charging into the airtight container.

The ceramic sintered body and the acidic liquid can be charged into the airtight container, for example, in air. As a result, the ceramic sintered body and the acidic liquid are exposed to air in the airtight container.

The airtight container may be any container as long as it can airtightly store a first mixture including the ceramic sintered body and the acidic liquid. A storage portion and a lid may be separate members, or the lid may be integrated with the storage portion. Examples of a material constituting the airtight container can include a metal, an alloy, and a fluororesin (for example, polytetrafluoroethylene (PTFE)). Examples of the airtight container can include a PTFE container of model HU series of reaction decomposition containers for high pressure manufactured by SAN-AI Kagaku Co. Ltd. The PTFE airtight container is resistant both to acid solutions and to high temperature and high pressure.

### <Step S2>

A temperature of the mixture (first mixture) of the ceramic sintered body and the acidic liquid contained in the airtight container is raised to 100° C. or higher and 400° C. or lower.

By setting the temperature of the first mixture to the range of 100° C. or higher and 400° C. or lower, a water vapor pressure in the airtight container can be increased to increase an internal pressure of the airtight container. The internal pressure is higher than atmospheric pressure. The pressure atmosphere contains air and water vapor. In a case where the first mixture is exposed to a pressure atmosphere having a temperature of 100° C. or higher and 400° C. or lower, dissolution of the filler in the ceramic sintered body in the acidic liquid can be promoted.

The internal pressure of the airtight container is desirably 0.23 MPa or more and 40 MPa or less. By setting the internal pressure to this range, it is possible to promote dissolution of the filler of the ceramic sintered body in the acidic liquid.

In a pressure atmosphere having a temperature of 100° C. or higher and 400° C. or lower and 0.23 MPa or more and 40 MPa or less, generation of a supercritical fluid can be avoided, and therefore dissolution of the filler of the ceramic sintered body in the acidic liquid can be promoted.

A time for treatment in the pressure atmosphere at a temperature of 100° C. or higher and 400° C. or lower is desirably 5 hours or more and 150 hours or less. By setting the treatment time to the above range, it is possible to increase an amount of the filler dissolved in the acidic liquid while suppressing the cost required for the treatment.

In the silicon nitride ceramic sintered body, the filler is present, for example, at a crystal grain boundary of silicon nitride. In step S2, since the filler in the ceramic sintered body is dissolved in the acidic liquid, the metal element M is extracted as an ion into the acidic liquid. An example of a reaction formula is MO+2H⁺->M²⁺+H₂O. On the other hand, since silicon nitride in the ceramic sintered body is not dissolved in the acidic liquid, silicon nitride remains as a solid. Therefore, a mixture (referred to as second mixture) containing the acidic liquid, an ion of the metal element M dissolved (extracted) in the acidic liquid, and a solid of silicon nitride is obtained.

### <Step S3>

The second mixture obtained in step S2 is cooled.

The cooling can be performed, for example, by air-cooling or water-cooling the airtight container.

The cooling is desirably performed until a temperature of the second mixture reaches room temperature or lower (for example, 25° C.). By cooling to room temperature or lower, the contents can be safely taken out from the container.

### <Step S4>

Solid liquid separation is performed on the second mixture.

A solid main component 1 is separated and recovered from the second mixture by solid liquid separation. The solid liquid separation is performed, for example, by filtration. The recovered solid main component 1 is rinsed (for example, washed with water) and dried as necessary. The recovered solid main component 1 may be mechanically pulverized. The mechanical pulverization is crushing by applying at least one or more forces of compression, impact, and shear. The recovered solid main component 1 is reused as a raw material for a ceramic sintered body or the like (step S5).

A liquid (for example, solution) 2 remaining after separation of the solid main component contains an ion of the metal element M. Each metal ion (Er ion (for example, Er³⁺), Y ion (for example, Y³⁺), Ti ion (for example, Ti⁴⁺), Mg ion (for example, Mg²⁺), Ce ion (for example, Ce⁴⁺)) is separated and recovered from the liquid 2 (step S6). Each metal ion separated from the liquid is desirably recovered as an elemental metal, a metal oxide, or a metal hydroxide. Examples of the separation and recovery method include an electrolytic deposition method, an ion exchange resin method, a solvent extraction method (for example, a chelating agent extraction method), a pH adjustment method, a precipitation separation method (for example, a salt precipitation method), and a chromatographic separation method. Any one method or a plurality of methods can be combined to perform separation and recovery.

According to the method of the first embodiment described above, a ceramic sintered body containing at least one metal element (metal element M) selected from the group consisting of a rare earth element, Ti, and Mg is brought into contact with an acidic liquid containing at least one selected from the group consisting of hydrochloric acid, nitric acid, and sulfuric acid in a pressure atmosphere at a temperature of 100° C. or higher and 400° C. or lower to obtain a second mixture containing a main component of the ceramic sintered body and an ion of the metal element M present in the acidic liquid. Since the main component of the ceramic sintered body is present as a solid in the second mixture, the main component of the ceramic sintered body can be easily recovered by solid liquid separation. In addition, the ion of the metal element M can be separated and recovered from the liquid from which the main component of the ceramic sintered body has been separated. Therefore, since the main component and the metal element M of the filler of the ceramic sintered body can be recovered from the ceramic sintered body, a reuse rate of the ceramic sintered body can be increased.

### Second Embodiment

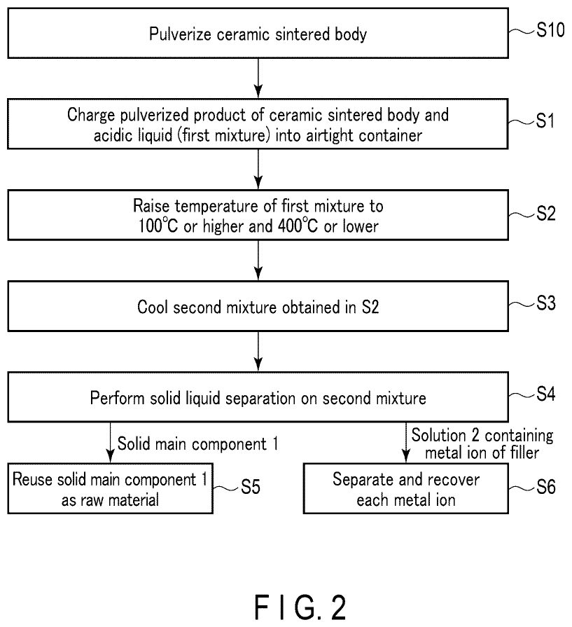

The recycling method of the second embodiment is carried out in the same manner as described for the method of the first embodiment, except that the ceramic sintered body is pulverized and an obtained powder of the ceramic sintered body is brought into contact with an acidic liquid. An example of the method of the second embodiment will be described with reference to FIG. 2. In FIG. 2, steps similar to those described with reference to FIG. 1 are denoted by the same reference numerals, and description thereof is omitted.

### <Step S10>

The ceramic sintered body is pulverized. Examples of the pulverization method can include mechanical pulverization and electric pulse pulverization. The mechanical pulverization is crushing by applying at least one or more forces of compression, impact, and shear. Examples of the mechanical pulverization can include pulverization by a dry pulverizer. Examples of the dry pulverizer can include a roll crusher, a jaw crusher, and a ball mill. A shape of the powder of the ceramic sintered body is not limited, and examples thereof can include a granular shape, a fibrous shape, and a scaly shape. A size of the powder of the ceramic sintered body is desirably 1 mm or less. A more preferable range is 0.05 mm or more and 1 mm or less. The size of the powder of the ceramic sintered body can be measured by, for example, sieving.

By pulverizing the ceramic sintered body, a solubility of the filler in the acidic liquid can be improved. Among the metal elements M, at least one of Ti or Mg is likely to provide a solubility improvement effect by pulverization.

According to the method of the second embodiment described above, since the ceramic sintered body is brought into contact with the acidic liquid after being pulverized, it can be expected that the solubility of the filler in the acidic liquid is improved. Therefore, the reuse rate of the ceramic sintered body can be further improved.

### EXAMPLES

Examples will be described later.

### Example 1

A waste material of a silicon nitride ceramic sintered body (0.036 g) was prepared. The composition of the silicon nitride ceramic sintered body is as follows. The main component was Si₃N₄. The filler includes Er₂O₃, Y₂O₃, MgO, and TiO₂. In a case where the weight of the main component was 1, the weight of the filler was 0.02 or more.

The waste material of the silicon nitride ceramic sintered body had a plate shape with a size larger than 1 mm. This material was used without pulverization.

The waste material of the silicon nitride ceramic sintered body and 1.9 g of a 18 by weight aqueous hydrochloric acid solution as the acidic liquid were placed in an airtight container (PTFE airtight container of model HU-25 manufactured by SAN-AI Kagaku Co. Ltd.) having an internal volume of 25 mL, and then mixed by stirring. Thereafter, the airtight container was sealed under atmospheric pressure.

When the temperature in the airtight container was raised to 146° C. by heating the airtight container in an oven, the internal pressure reached the value shown in Table 1. The treatment at set high temperature and high pressure was performed for 5 hours. Thereafter, the temperature in the airtight container was cooled to 25° C.

Next, a mixture (second mixture) of a solid and a liquid in the airtight container was recovered. The solid was silicon nitride (Si₃N₄). The liquid was an aqueous hydrochloric acid solution. Er³⁺, Y³⁺, Ti⁴⁺, and Mg²⁺ were present in the aqueous hydrochloric acid solution. The second mixture was filtered to separate and recover the solid of silicon nitride from the second mixture. The recovered solid of silicon nitride was rinsed and then dried to obtain regenerated silicon nitride.

The metal ion concentration of each of Er³⁺, Y³⁺, Ti⁴⁺, and Mg²⁺ in an obtained filtrate was measured by inductively coupled plasma mass spectrometry (ICP-MS). In addition, each metal ion concentration (mol/L) in a case where the filler containing each metal contained in the amount (0.036 g) of the waste material of the silicon nitride ceramic sintered body used in Examples was completely dissolved in 1.9 g of the 18 by weight aqueous hydrochloric acid solution was calculated as a reference concentration. Each metal ion concentration of the filtrate is compared with the reference concentration, and the value (%) of each metal ion concentration of the filtrate in a case where the reference concentration is 100% is shown as the solubility (%) of each metal element in Table 1.

In addition, Er³⁺, Y³⁺, Ti⁴⁺, and Mg²⁺ can be separated from the filtrate by pH adjustment and a salt precipitation method. An oxide can be obtained by converting each metal ion into a hydroxide or a carbonate and thermally decomposing the hydroxide or the carbonate. Therefore, it can be recovered as an oxide of each metal element.

### Example 2

As a waste material of a silicon nitride ceramic sintered body, a waste material of a silicon nitride ceramic sintered body having the same composition as in Example 1 was prepared. The amount of the waste material used is the same as in Example 1. The waste material of the silicon nitride ceramic sintered body was mechanically pulverized using an agate mortar, and sieved to obtain a powder having a size in a range of 500 μm or more and 1 mm or less. A recycling treatment was performed in the same manner as in Example 1 except that the obtained powder was used as a target for treatment with an acidic liquid.

### Example 3

As a waste material of a silicon nitride ceramic sintered body, a waste material of a silicon nitride ceramic sintered body having the same composition as in Example 1 was prepared. The amount of the waste material used is the same as in Example 1. The waste material of the silicon nitride ceramic sintered body was mechanically pulverized using an agate mortar, and sieved to obtain a powder having a size in a range of 106 μm or more and 500 μm or less. A recycling treatment was performed in the same manner as in Example 1 except that the obtained powder was used as a target for treatment with an acidic liquid.

### Example 4

As a waste material of a silicon nitride ceramic sintered body, a waste material of a silicon nitride ceramic sintered body having the same composition as in Example 1 was prepared. The amount of the waste material used is the same as in Example 1. The waste material of the silicon nitride ceramic sintered body was mechanically pulverized using an agate mortar, and sieved to obtain a powder having a size in a range of 53 μm or more and 106 μm or less. A recycling treatment was performed in the same manner as in Example 1 except that the obtained powder was used as a target for treatment with an acidic liquid.

### Comparative Example 1

A powder of a silicon nitride ceramic sintered body obtained by the same method as in Example 3 and the same acidic liquid as in Example 1 were placed in an airtight container, and then mixed by stirring. Thereafter, the airtight container was sealed under atmospheric pressure. When the temperature in the airtight container was set to room temperature, the internal pressure reached the value shown in Table 1. The treatment under set conditions was performed for 5 hours. Cooling after the treatment was not performed. Except for these, a recycling treatment was performed in the same manner as in Example 1.

### Comparative Example 2

A powder of a silicon nitride ceramic sintered body obtained by the same method as in Example 3 and 1.9 g of a 1% by weight aqueous hydrofluoric acid solution (hydrofluoric acid) were placed in an airtight container, and then mixed by stirring. Thereafter, the airtight container was sealed under atmospheric pressure. When the temperature in the airtight container was set to room temperature, the internal pressure reached the value shown in Table 1. The treatment under set conditions was performed for 5 hours. Cooling after the treatment was not performed. Except for these, a recycling treatment was performed in the same manner as in Example 1.

The solubility of each of the metal elements Er, Y, Ti, and Mg in Examples 1 to 4 and Comparative Examples 1 and 2 is shown in Table 1. Here, for each of Examples 1 to 8 and Comparative Examples 1 and 2, the reference concentration of each metal element is the metal ion concentration in a case where the filler of each metal element is completely dissolved in the treatment liquid used in each example, assuming that the amount of the filler of each metal element is equal to the total amount of the filler. In consideration of the acid dissociation constant, the concentration of the aqueous acid solution was made excessive relative to the amount of the acid in which all the fillers were exactly dissolved.

TABLE 1

| | | | | Treatment | Treatment | | | | |
|---|---|---|---|---|---|---|---|---|---|
| | Sintered | Treatment | Treatment | temperature | pressure | Er | Y | Ti | Mg |
| | body size | liquid | time | (° C.) | (MPa) | Solubility | Solubility | Solubility | Solubility |
| Example 1 | more than | 1 wt % | 5 h | 146° C. | 0.56 | 83.8% | 83.7% | 7.7% | 74.2% |
| | 1 mm | hydrochloric | | | | | | | |
| | | acid | | | | | | | |
| Example 2 | 500 μm to | 1 wt % | | 146° C. | 0.56 | 82.9% | 82.6% | 8.8% | 84.6% |
| | 1 mm | hydrochloric | | | | | | | |
| | | acid | | | | | | | |
| Example 3 | 106 μm to | 1 wt % | | 146° C. | 0.56 | 84.7% | 84.5% | 18.0% | 84.2% |
| | 500 μm | hydrochloric | | | | | | | |
| | | acid | | | | | | | |
| Example 4 | 53 μm to | 1 wt % | | 146° C. | 0.56 | 84.9% | 84.1% | 64.9% | 90.3% |
| | 106 μm | hydrochloric | | | | | | | |
| | | acid | | | | | | | |
| Comparative | 106 μm to | 1 wt % | | room | 0.10 | 41.0% | 40.6% | 3.6% | 37.5% |
| Example 1 | 500 μm | hydrochloric | | temperature | | | | | |
| | | acid | | | | | | | |
| Comparative | 106 μm to | 1 wt % | 5 h | room | 0.10 | 3.0% | 2.2% | 4.7% | 6.4% |
| Example 2 | 500 μm | hydrochloric | | temperature | | | | | |
| | | acid | | | | | | | |

As is apparent from Table 1, according to the methods of Examples 1 to 4, the solubility of each of the metal elements Er, Y, Ti, and Mg was higher than those in the methods of Comparative Examples 1 and 2. The method of Comparative Example 1 is a treatment method similar to that of Example 3 except that the treatment temperature is room temperature and the internal pressure is equal to the atmospheric pressure. Even if an acidic liquid containing hydrochloric acid is used, the solubilities of the metal elements in the filtrate decrease if the treatment temperature is low. As a result, not only a recovery rate of the metal element from the waste material decreases, but also it becomes difficult to separate a single unit of silicon nitride from the waste material. Therefore, both the solid of silicon nitride and the metal element have a low recovery rate. On the other hand, the method of Comparative Example 2 is a treatment method similar to that of Comparative Example 1 except that a hydrofluoric acid solution is used as the acidic liquid. When hydrogen fluoride was used instead of hydrochloric acid, the solubilities of the metal elements in the filtrate were further reduced. In addition, since silicon nitride was dissolved in the acidic liquid, the recovery rate of silicon nitride was also low.

Comparison of Examples 1 to 4 shows that the solubilities of the metal elements (Er, Y, Ti, and Mg) in the filtrate tend to increase as the size of the silicon nitride ceramic sintered body is smaller. Therefore, it is desirable to bring the powder obtained by pulverizing the silicon nitride ceramic sintered body into contact with the acidic liquid.

### Example 5

A powder of a silicon nitride ceramic sintered body obtained by the same method as in Example 3 and 1.9 g of a 1% by weight aqueous sulfuric acid solution as the acidic liquid were placed in an airtight container having an internal volume of 25 mL, and then mixed by stirring. Thereafter, the airtight container was sealed under atmospheric pressure.

When the temperature in the airtight container was raised to 146° C. by heating the airtight container in an oven, the internal pressure reached the value shown in Table 2. The treatment at a high temperature and a high pressure was performed for 5 hours. Thereafter, the temperature in the airtight container was cooled to 25° C. After this step, a recycling treatment was performed in the same manner as in Example 1.

### Example 6

A powder of a silicon nitride ceramic sintered body obtained by the same method as in Example 3 and 1.9 g of a 1% by weight aqueous nitric acid solution as the acidic liquid were placed in an airtight container having an internal volume of 25 mL, and then mixed by stirring. Thereafter, the airtight container was sealed under atmospheric pressure.

When the temperature in the airtight container was raised to 146° C. by heating the airtight container in an oven, the internal pressure reached the value shown in Table 2. The treatment at a high temperature and a high pressure was performed for 5 hours. Thereafter, the temperature in the airtight container was cooled to 25° C. After this step, a recycling treatment was performed in the same manner as in Example 1.

The solubility of each of the metal elements Er, Y, Ti, and Mg in Examples 5 and 6 is shown in Table 2. Table 2 also shows the data of Example 3.

TABLE 2

| | Treatment | Sintered | Liquid | Heating | Er | Y | Ti | Mg |
|---|---|---|---|---|---|---|---|---|
| | liquid | body size | amount | conditions | Solubility | Solubility | Solubility | Solubility |
| Example 3 | 1 wt % HCl | 106 μm to | 1.9 g | 146° C. | 84.7% | 84.5% | 18.0% | 84.2% |
| | | 500 μm | | 5 h | | | | |
| | | | | 0.56 MPa | | | | |
| Example 5 | 1 wt % H₂SO₄ | 106 μm to | 1.9 g | 146° C. | 83.5% | 81.6% | 72.5% | 90.0% |
| | | 500 μm | | 5 h | | | | |
| | | | | 0.56 MPa | | | | |
| Example 6 | 1 wt % HNO₃ | 106 μm to | 1.9 g | 146° C. | 89.2% | 89.6% | 72.5% | 100.7% |
| | | 500 μm | | 5 h | | | | |
| | | | | 0.56 MPa | | | | |

As is apparent from Table 2, when the method of Example 5 in which the type of acid was changed from hydrochloric acid to sulfuric acid was compared with the method of Example 3 using hydrochloric acid in the acidic liquid, the solubility of each of the metal elements Er, Y, and Mg was comparable to that in Example 3, and the solubility of Ti was higher than that in Example 3. In addition, in the method of Example 5 in which the type of acid was changed from hydrochloric acid to nitric acid, the solubility of each metal element of Er, Y, Ti, and Mg was higher than that in Example 3.

### Example 7

A powder of a silicon nitride ceramic sintered body obtained by the same method as in Example 3 and 10 g of a 1% by weight aqueous hydrochloric acid solution as the acidic liquid were placed in an airtight container having an internal volume of 25 mL, and then mixed by stirring. Thereafter, the airtight container was sealed under atmospheric pressure.

When the temperature in the airtight container was raised to 146° C. by heating the airtight container in an oven, the internal pressure reached 0.56 MPa. The treatment at set high temperature and high pressure was performed for 24 hours. Thereafter, the temperature in the airtight container was cooled to 25° C. After this step, a recycling treatment was performed in the same manner as in Example 1.

### Example 8

A powder of a silicon nitride ceramic sintered body obtained by the same method as in Example 3 and 10 g of a 10% by weight aqueous hydrochloric acid solution as the acidic liquid were placed in an airtight container having an internal volume of 25 mL, and then mixed by stirring. Thereafter, the airtight container was sealed under atmospheric pressure.

When the temperature in the airtight container was raised to 146° C. by heating the airtight container in an oven, the internal pressure reached 0.56 MPa. The treatment at set high temperature and high pressure was performed for 24 hours. Thereafter, the temperature in the airtight container was cooled to 25° C. After this step, a recycling treatment was performed in the same manner as in Example 1.

The solubility of each of the metal elements Er, Y, Ti, and Mg in Examples 7 and 8 is shown in Table 3. Table 3 also shows the data of Example 3.

TABLE 3

| | Treatment | Sintered | Liquid | | Treatment | Er | Y | Ti | Mg |
|---|---|---|---|---|---|---|---|---|---|
| | liquid | body size | amount | Concentration | time | Solubility | Solubility | Solubility | Solubility |
| Example 3 | HCl | 106 μm to | 1.9 g | 1 wt % | 5 h | 84.7% | 84.5% | 18.0% | 84.2% |
| Example 7 | | 500 μm | 10.0 g | 1 wt % | 24 h | 78.7% | 79.9% | 81.6% | 86.326% |
| Example 8 | | | 10.0 g | 10 wt % | 24 h | 104.7% | 102.9% | 123.1% | 111.3% |

As is apparent from Table 3, comparison between Example 3 and Example 7 shows that, in a case where the concentrations of the acidic liquids are equal, the solubilities of the metal elements tend to be higher as the treatment time is longer. This tendency was remarkable when the types of elements were Ti and Mg. Also, comparison between Example 7 and Example 8 shows that, in a case where the treatment times are equal, the solubilities of the metal elements tend to be higher as the concentration of the acidic liquid is higher. This tendency was observed in any of Er, Y, Ti, and Mg.

According to the method of at least one embodiment described above, a ceramic sintered body containing at least one metal element (metal element M) selected from the group consisting of a rare earth element, Ti, and Mg is brought into contact with an acidic liquid containing at least one selected from the group consisting of hydrochloric acid, nitric acid, and sulfuric acid in a pressure atmosphere at a temperature of 100° C. or higher and 400° C. or lower to obtain a mixture containing a main component of the ceramic sintered body and an ion of the metal element M present in the acidic liquid. Since the main component of the ceramic sintered body is present as a solid in the mixture, the main component of the ceramic sintered body can be easily recovered by solid liquid separation. In addition, the ion of the metal element M can be separated and recovered from the liquid from which the main component of the ceramic sintered body has been separated. Therefore, since the main component and the metal element M of the filler of the ceramic sintered body can be recovered from the ceramic sintered body, the reuse rate of the ceramic sintered body can be increased.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for recycling a ceramic sintered body, the method comprising:
bringing a ceramic sintered body comprising at least one metal element selected from the group consisting of a rare earth element, Ti, and Mg into contact with an acidic liquid comprising at least one selected from the group consisting of hydrochloric acid, nitric acid, and sulfuric acid in a pressure atmosphere at a temperature of from 100° C. to 400° C. to obtain a mixture comprising a main component of the ceramic sintered body and an ion of the at least one metal element present in the acidic liquid;
separating the main component of the ceramic sintered body from the mixture; and
separating the ion of the at least one metal element from the acidic liquid.

2. The method for recycling a ceramic sintered body according to claim 1, wherein a pressure of the pressure atmosphere is from 0.23 MPa to 40 MPa.

3. The method for recycling a ceramic sintered body according to claim 1, wherein the pressure atmosphere comprises water vapor.

4. The method for recycling a ceramic sintered body according to claim 1, wherein the main component of the ceramic sintered body is separated and recovered from the mixture by solid liquid separation.

5. The method for recycling a ceramic sintered body according to claim 1, wherein the ion of the at least one metal element is separated and recovered from the acidic liquid by at least one selected from the group consisting of an electrolytic deposition method, an ion exchange resin method, a solvent extraction method, a pH adjustment method, a precipitation separation method, and a chromatographic separation method.

6. The method for recycling a ceramic sintered body according to claim 1, further comprising pulverizing the ceramic sintered body before bringing the ceramic sintered body into contact with the acidic liquid.

7. The method for recycling a ceramic sintered body according to claim 1, wherein an acid concentration of the acidic liquid is from 18 by weight to 30% by weight.

8. The method for recycling a ceramic sintered body according to claim 1, wherein the ceramic sintered body further comprises as a main component at least one selected from the group consisting of silicon nitride, aluminum nitride, silicon carbide, and titanium carbide.

9. The method for recycling a ceramic sintered body according to claim 1, wherein the ceramic sintered body comprises an oxide of the at least one metal element.
